(19) United States
(12) Patent Application Publication
(10) Pub. No.: US 2012/0130641 A1
(43) Pub. Date: May 24, 2012

(54) Marine Source To Borehole Electromagnetic Mapping Of Sub-Bottom Electrical Resistivity

(76) Inventors: H. Frank Morrison, Berkeley, CA (US); Garrett Kramer, Monza-Brianza (IT); Edward Nichols, Berkeley, CA (US); David L. Alumbaugh, Berkeley, CA (US); Michael J. Tompkins, San Francisco, CA (US)

(21) Appl. No.: 13/263,830

(22) PCT Filed: Apr. 8, 2010
(86) PCT No.: PCT/US10/30431

§ 371 Date: Feb. 13, 2012

Related U.S. Application Data
(60) Provisional application No. 61/168,282, filed on Apr. 10, 2009.

(51) Int. Cl. G06F 19/00; G01V 3/18

(52) U.S. Cl. 702/7; 324/338

(57) ABSTRACT

A towed marine source to borehole electromagnetic survey system and method for surveying employing the same is disclosed. The system includes a sea vessel adapted for traversal of sea water over a subsea formation, a power supply affixed to the sea vessel and a high moment loop source coupled to the power supply, and a signal generator by a tow cable; said signal generator being affixed to the sea vessel configured to control operating parameters of the high moment loop source. The system also includes a wellbore drilled in the subsea formation, a series of electromagnetic (EM) receivers positioned in the wellbore. Each receiver includes a sensor module having sensing elements to measure one or more of electric fields, electric currents, and magnetic fields produced by the high moment loop source when towed by the sea vessel, and a storage device configured to store data from measurements made by the sensor module. The system further includes a computer processor configured to receive stored data from the receivers and analyze the stored measurement data to determine a location of an electrically resistive formation anomaly at a depth of between 1 to 5 km.

### CROSS-REFERENCE TO OTHER APPLICATIONS

This application claims priority to and the benefit of U.S. Provisional Application No. 61/168,282, filed provisionally on Apr. 10, 2009.

### TECHNICAL FIELD

The invention relates generally to electromagnetic survey systems and techniques and particularly to systems and methods for a survey geometry having a very large moment source in the ocean with receiver in a borehole, enabling new EM schemes with increased depth of investigation, resolution and spatial coverage that could not practically be achieved on land.

### BACKGROUND

The search for hydrocarbons reservoirs involves locating portions of rock formations that host economically recoverable amounts of petroleum or natural gas in the pores of the formation. Seismic methods are widely used to identify structural features of formations that serve to ‘trap’ hydrocarbons. Often seismic resolution of these features is compromised by variations in seismic velocity above the structure or by excessive scattering of the seismic waves by overlying formations as is the case for reservoirs located beneath salt or basalt formations.

Electromagnetic methods are used to map the electrical resistivity in rock formations. The rock resistivity is a function of the resistivity of the pore fluids. Since gas and oil are electrical insulators, their presence renders the formation resistive compared to normal brine filled porous rocks. Measurement of the distribution of electrical resistivity in a formation thus becomes a valuable tool in locating petroleum reservoirs which were unseen by seismic methods or which were missed in drilling.

Electromagnetic methods are long established standard procedures used in wells drilled for hydrocarbon. Logging tools that determine the electrical resistivity in the near vicinity of a well are used routinely to assess the amount of hydrocarbon in the formation (referred to as the oil saturation). These techniques have a range of investigation measured in tens of meters at the most and are not useful in detecting reservoirs that are hundreds of meters or more from the well.

If more than one well is available, there has been recent success using EM methods to map the resistivity between wells (Wilt, M. J., et al., 1995, Crosswell electromagnetic tomography: System design considerations and field results; Geophysics 60, 871). In crosswell tomography applications, the goal has been to locate bypassed oil and to monitor various enhanced recovery techniques over time.

On a larger scale there have been many EM methods utilized for mapping the subsurface resistivity from the surface. The methods have inherently low resolution but have been used successfully to locate potential reservoirs beneath salt and basalt formations, situations difficult or impossible for seismic methods (e.g. Wilt, M. J., et al., 1989, Electromagnetic sounding in the Columbia Basin, Yakima, Wash.; Geophysics 54, 952). More recently marine electromagnetic methods are being widely used to locate reservoirs within sedimentary rocks covered by seawater. The sources for EM energy used in this marine technology have opened up new possibilities for subsurface exploration for, and delineation of, reservoirs in the vicinity of a single well drilled into the prospective reservoir region.

Surface to borehole EM (as well as borehole to surface configuration) surveys have been described in detail in applications commonly owned with the present application, including:
U.S. patent application Ser. No. 12/719730 filed Mar. 8, 2010, entitled “Electromagnetic Detection of Base of Salt While Drilling” (Atty. Docket 23.0703),
U.S. patent application Ser. No. 12/581,947 filed Oct. 20, 2009 entitled “Detecting Electrical Current in a Magnetic Structure” (Atty. Docket 23.0692),
U.S. patent application Ser. No. 12/641,944 filed Dec. 18, 2009, entitled “Correction Factors For Electromagnetic Measurements Made through Conductive Material” (Atty. Docket 23.0711),
U.S. patent application Ser. No. 12/641,898 filed Dec. 18, 2009, entitled “Attenuation of Electromagnetic Signals Passing Through Conductive Material” (Atty. Docket 23.0710),
U.S. patent application Ser. No. 12/603,053 filed Oct. 21, 2009, entitled “Electromagnetic Logging Between Borehole and Surface” (Atty. Docket 23.0706), and
U.S. patent application Ser. No. 12/405,214 filed Mar. 16, 2009, entitled “Casing Correction in Non-magnetic Casing by the Measurement of the Impedance of a Transmitter or Receiver” (Atty. Docket 23.0704).
U.S. patent application Ser. No. filed 12/696,267 filed Jan. 29, 2010, entitled “System and Method for Elevated Source to Borehole Electromagnetic Survey” (Atty. Docket 23.0705).

Each of the above shares a common assignee with the present application, and is incorporated herein by reference in its entirety.

### BRIEF DESCRIPTION OF THE DRAWINGS

FIG. 1 shows a canonical marine electromagnetic model, in accordance with embodiments of the present disclosure.

FIG. 2 graphs the signal amplitude contoured as a function of T offset and R depth for the marine model of FIG. 1, in accordance with embodiments of the present disclosure.

FIG. 3 shows a marine model with a missed reservoir, in accordance with embodiments of the present disclosure.

FIG. 4 graphs amplitude sensitivity in percent (%) to a thin resister 500 meters away from the borehole, in accordance with embodiments of the present disclosure.

FIG. 5 shows a marine model with a deep towed marine source in 2 km of seawater, in accordance with embodiments of the present disclosure.

FIG. 6 shows the plotted response for the configuration of FIG. 5, in accordance with embodiments of the present disclosure.

FIG. 7 shows a marine model with a shallow towed marine source in 2 km of seawater, in accordance with embodiments of the present disclosure.

FIG. 8 shows the plotted response for the configuration of FIG. 7, in accordance with embodiments of the present disclosure.

FIG. 9 illustrates a flowchart of one method for marine source-to-borehole electromagnetic mapping of sub-bottom electrical resistivity, in accordance with embodiments of the present disclosure.

FIG. 10 illustrates a computer system that can be used to perform tasks according to an embodiment of the present disclosure.

### DETAILED DESCRIPTION

In the following description, numerous details are set forth to provide an understanding of the present disclosure. However, it will be understood by those skilled in the art that the present invention may be practiced without these details and that numerous variations or modifications from the described embodiments are possible.

The following terms have a specialized meaning in this disclosure. While many are consistent with the meanings that would be attributed to them by a person having ordinary skill in the art, the meanings are also specified here.

The electromagnetic (EM) methods discussed here rely on a source, here after referred to as a transmitter, T, of either changing magnetic field (usually a loop of time varying current) or direct current injection into the medium via a power supply and contacting electrodes. For the loop T, the time changing magnetic field induces electrical currents in the formation which in turn produce their own magnetic fields called the secondary fields. The magnitude and flow patterns of the induced currents depends on the distribution of the electrical resistivity of the ground and so, indirectly, measured secondary fields at a suitable receiver, R, are interpreted in terms of the resistivity distribution. For the injected current T, there are effectively two mechanisms at work: the injected current flow is distorted by the resistivity distribution, even at dc, but there is a second effect with alternating current in which the time varying magnetic field of the injected current itself introduces additional currents with their secondary magnetic fields. Magnetic fields, B, are expressed here in nanoTeslas (nT) and electric fields, E, are expressed in Volts per meter (V/m).

Since both the current flow, and hence the electric field measured between two receiver electrodes, and the secondary magnetic field are both related to the resistivity distribution, it is desirable to measure both electric and magnetic field with appropriate electrode arrays and/or magnetic field sensors.

This seemingly complicated current-field interaction has been thoroughly investigated and the underlying theory and means of predicting and interpreting actual field measurements is well understood (e.g. Hohman, G. R., 1991, Electromagnetic Methods in Applied Geophysics, Society of Exploration Geophysicists). EM surveys are limited in practice by technical constraints on the strength of the source and the sensitivity and noise level of the sensors used to measure the electric and magnetic fields.

The strength of loop transmitters is measured by the product of the number of turns on the loop, N, the current flowing in these turns I (Amp) and the area of the loop A (m²). The magnetic moment, MB (amp.m²), is the product NIA. For a sense of scale, commercial EM systems often use a large loop placed, horizontally, on the ground with moments ranging from 10⁴ to 10⁷ Amp.m².

The strength of a current injection transmitter is measured by the electric moment, ME (Amp.m) the product of the injected current I (Amp) and the length of cable, L, between the electrodes. Typical land sources have IL products of 10³ to 10⁵. Systems have used IL products as high as 10⁶ Amp.m for petroleum exploration (e.g. Keller, G. V., et al., 1984, Meagasource time-domain electromagnetic sounding methods; Geophysics 49, 993).

In general, it is known that for exploration to depths of several kilometers the sources need to be very large and the practical difficulties of deployment, and large power required have greatly restricted their effectiveness and use in land applications. In the marine environment, however, the situation is very different.

Electrodes for introducing current into seawater are simple and easy to emplace and a pair of towed electrodes injecting high current over a heavy cable up to 300 m long is practical. The present state of the art marine controlled source EM (CSEM) system deployed by Western Geco Electromagnetics has an electric moment of 3×10⁵ Amp.m. Furthermore, the electrode system is easily towed at depth and with multiple receivers emplaced on the ocean bottom; it provides multiple source positions for continuous profiling of the sub bottom resistivity structure (e.g. Ellingsrud, S. et al., 2002, Remote sensing of hydrocarbon layers by seabed logging (SBL): Results from a cruise offshore Angola; The Leading Edge October 2002, 972), a feature virtually impossible for land-based sources.

More recently, we have demonstrated a commercial system in which one electrode is dropped from a ship on a heavy cable to the ocean bottom and another deployed a few tens of meters below the ship producing a vertical current source with a moment of 3×10⁶ Amp.m. Receivers are autonomous horizontal and vertical electrode systems placed on the sea floor. Such a source might be achieved in a drill hole on land but, limited by a land application, would not have the ability to be moved around to achieve useful spatial coverage.

Both the horizontal and vertical electric sources, coupled with the measurements of magnetic and electric fields have demonstrated success finding those portions of a thin formation containing oil at depths of up to 2.5 km.

A new magnetic source that has not been previously used in any system is discussed here for the first time. The experience gained in the deployment of horizontal and vertical electric moments, and inclined moments (e.g. marine inclined source patent, U.S. Pat. No. 7,659,724 (Atty. Docket No. 115.0014, entitled “Surveying method using an arrangement of plural signals sources”) led us to realize that it would be feasible to deploy a large vertical loop in the ocean. A simple single turn loop of 10⁵ m² carrying 100 Amp would produce a magnetic moment of 10⁷ Amp.m². Such a horizontal magnetic moment is impractical on land and has not been proposed for land applications.

It is, however, possible to utilize very large moment sources in the ocean. This has permitted the development of new survey schemes with deeper depth of investigation, resolution and spatial coverage that could not practically be achieved on land.

The development of these marine electric source methods has brought about a new fundamental understanding of the response of a variety of reservoir models to previously unconsidered sources. It has also led to the development of powerful numerical codes used to predict responses from simple representative 2-D and 3-D models for reservoirs.

We have investigated the practical feasibility of using marine sources with receiver sensors in a borehole to determine the resistivity distribution up to hundreds of meters or even a kilometer from the borehole. Such configurations provide far higher resolution of deep features than could be achieved from surface or ocean-floor based transmitter-receiver methods.

In any EM system the transmitter-receiver configuration must yield a measurable change in response for a desired geologic model of a target, e.g. a reservoir, compared to the background formation and structure without the target. Measurable in this context means that the source moment must be large enough so that the change in model response is larger than the noise level of the receiver. For example, for the above mentioned marine CSEM a goal is often to find those portions of a thin (on the order of tens of meters) formation that are filled with oil, or resistive. For current marine CSEM systems, simple layered model simulations show remarkable sensitivity for the horizontal and vertical electric sources where the electric fields are measured at receivers on the ocean bottom. For a variety of theoretical reasons, one of the most sensitive configurations for this model is that of a vertical current source with relatively closely spaced vertical electric field receivers, a configuration that would be very impractical on land.

One configuration in accordance with the present disclosure exploits a response to deep (1-5 km) resistivity features of interest that has not been considered for land-based systems because of the previously mentioned difficulties with emplacing moveable and powerful electrode systems on land. The new configuration responds to the practical need to map resistivity around a borehole to detect regions of resistivity indicative of oil saturation that would not be discernable with seismic techniques or with seabed-based EM methods.

To illustrate the application, we present a sample scenario. Other reservoir or mapping problems that could be addressed with the survey geometry presented here will be obvious to a trained petroleum reservoir engineer/explorationist.

A simple scenario includes oil located in a bounded region in a thin layer at a depth of 3 km beneath the ocean floor. The seismic identification of the structure is in error by as much as 500 m because of small and poorly defined errors in the velocity estimation of the overlying sediments. A well is drilled to the anticipated depth and no oil is encountered. As we will see in the simple numerical simulation presented below, the response of an electric source on the ocean floor to the thin resistive zone 500 m away from the well is easily measured by either a vertical electric or horizontal magnetic sensor in the well. Furthermore, with the ability to move the source around in the ocean, radial and azimuthal source positions can accurately locate the position of the oil interface in space. A few simple calculations serve to illustrate the practicality of these measurements and of our invention.

First there are some broad considerations for selecting the useful range of frequencies to be used for the alternating current sources. For loop sources as the frequency decreases the induced currents vanish leaving no electric fields and leaving magnetic fields that are the same as those that would be measured in free space. At very low frequencies there is simply no response from the medium with or without resistive zones. As the frequency increases, induced currents flow and are distorted by zones of varying resistivity (e.g. forced to flow around a resistive zone). The induced currents are directly detected by electric field receivers or indirectly by magnetic receivers sensing the secondary magnetic fields from the currents. As the frequency increases further skin depth effects attenuate the inducing magnetic field. Roughly, fields are attenuated by 1/e over a distance δ, the skin depth, given by 500 √ρ/f where ρ is the resistivity (ohm.m) and f the frequency (Hz). For fields to produce measurable currents at a depth d in the ground the depth should be on the order of 1 to 3 skin depths. So in a 1 ohm.m half space, measurements at a depth of 3 km in a bore hole should be made with frequencies of ˜0.03 to ˜1.0 Hz.

For current sources the situation is a little different. At low frequency, including DC, there are measurable magnetic and electric fields. The currents are distorted by the nearby resistive zone and magnetic and electric fields measured nearby are affected by the zone. However the distortion of the secondary induced currents at higher frequency may be greater than at DC and in practice the same frequency window used for magnetic sources is found to be best.

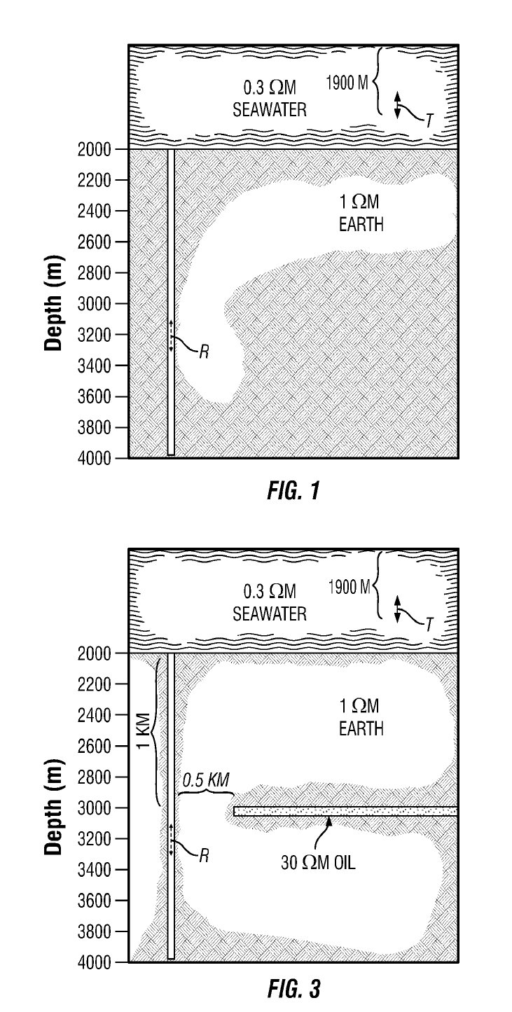

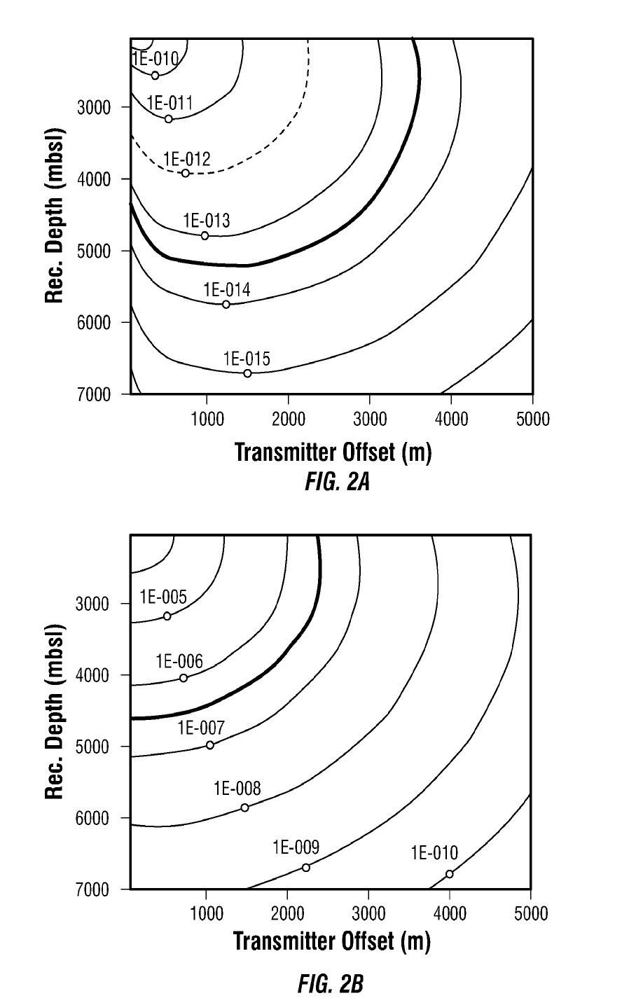

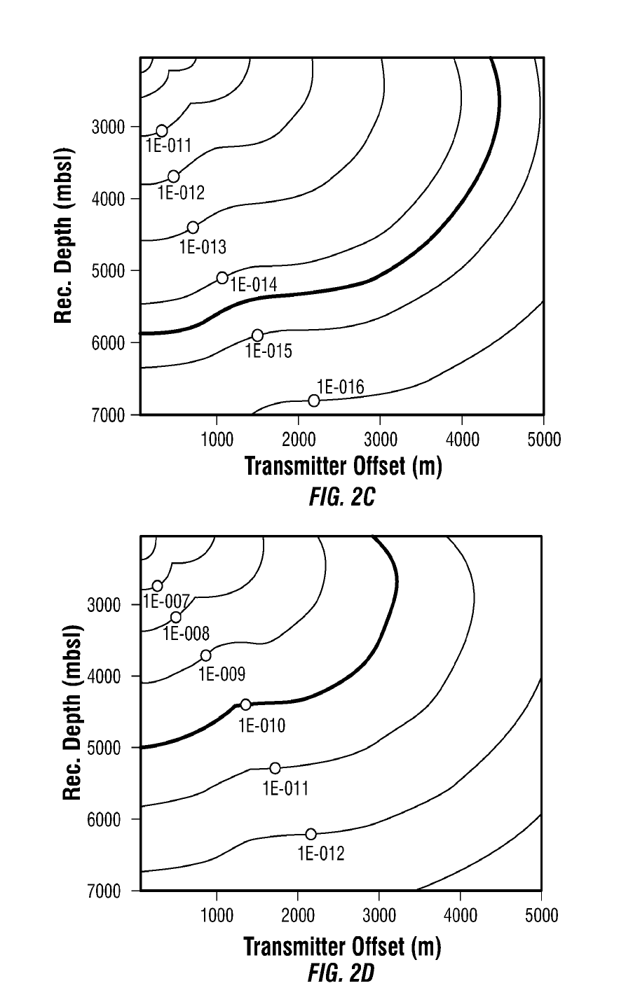

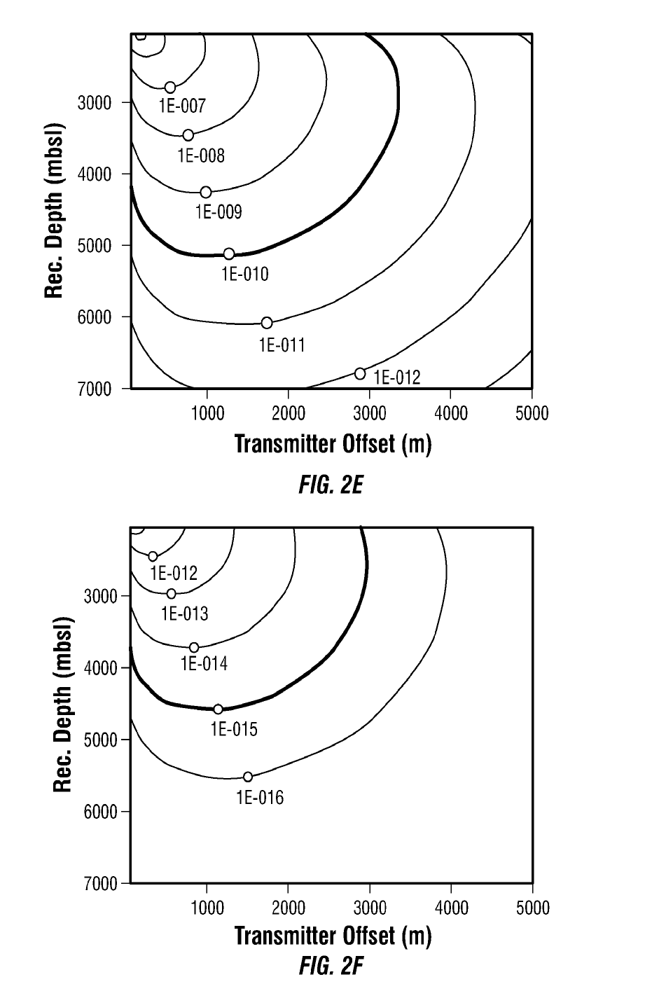

To illustrate the principles and practice of this invention we have chosen a half space of 1 ohm.m, an overlying ocean of 2 km depth and an operating frequency for the source of 1 Hz. (FIG. 1). For example in FIG. 2a we plot contours of the amplitude of the vertical electric field measured vs. depth in a borehole, in V/m, for a horizontal electrical dipole source of moment one as a function of transmitter offset (radial distance from well). For example, the field in the borehole from a horizontal transmitter offset three kilometers at a depth of 5000 meters is 10⁻¹⁴ V/m. With a source moment of 3×10⁵ Amp.m (currently used in the marine CSEM system) the field is therefore 3×10⁻⁹ V/m. A typical electric receiver has a noise level of 10⁻⁹ V/m (from actual field measurements) so the ‘signal’ would be 3 times the noise without considering any additional signal averaging techniques

To facilitate the comparison of different sources and receivers we have chosen two representative electric moments: a horizontal moment MEx of 3×10⁵ and a vertical moment MEz of 3×10⁶ Amp.m. The lowercase letter describes the rectangular coordinate direction of the source. We have also included the new vertical loop source with a horizontal magnetic moment MBx or MBy of 10⁷ Amp.m² (here×is the radial coordinate from the borehole and y is the coordinate perpendicular to the plane containing the borehole and the radius). The observed noise level for electric field receivers on the ocean floor and in boreholes is 10⁻⁹ V/m. The noise level for vertical magnetic sensors in a borehole, Bz is 10⁻⁴ nT and two orders of magnitude less for horizontal magnetic sensors in a borehole, Bx or By. (Long induction sensors have much higher sensitivity than either short induction sensors or fluxgate sensors that would fit transverse to the borehole axis). We can therefore normalize a desired signal in either field by the appropriate moment to plot amplitudes for unit moment as shown in FIG. 2. For the chosen MEx and a desired signal level of 100 times the noise level, i.e. 100×10⁻⁹ V/m or 10⁻⁷ V/m. We have further assumed that an increase in signal to noise of a factor of 10 could be achieved through signal averaging so the final the required amplitude contour is 3×10⁻¹⁴ V/m. This contour is drawn with a heavy line in FIG. 2a.

From all the possible Tx-to-Rx configurations, we plotted the desired signal level contour on the depth offset plots and have shown in FIG. 2a-2e those which yield practical signal levels at useful depth ranges. In summary vertical electric borehole fields from horizontal or vertical electric sources or from y-directed magnetic dipoles yield useful signals at depths up to 3 km (below sea floor) and greater.

For magnetic field borehole receivers the only practical sources appear to be an x-directed electric source for By, FIG. 2b. A vertical magnetic moment on the ocean bottom can also produce useful vertical magnetic fields, FIG. 2d.

Powerful electric and magnetic sources that are possible in marine deployment provide practical levels of magnetic and electric field strengths at depths of 3 km and more in boreholes. Note that these fields will be of sufficient energy that the energy can be received by a borehole tool and that this disclosure does not differentiate between receiving these tools with an embodiment that is measured while drilling, measured in the open hole or measured by a tool after the energy has propagated through steel casing. The distortions caused by the presence of steel casing needs to be corrected for, however one notices that especially for the magnetic fields, the low frequencies involved results in relatively minor distortions. For the electric fields, the large conductivity contrasts between the casing and the formation mean that care will need to be exercised to address these effects.

While this analysis has shown the feasibility of measuring the fields at depths far beyond the reach of surface or ocean based T-R systems, it remains to be shown that these fields are indeed sensitive to the nearby resistivity distribution that is indicative of oil-water boundaries. We have used the model of FIG. 3 to represent and oil water contact 500 m to the right of a borehole. In this case, drilling missed the oil reservoir. The objective is to determine that the oil layer is present. We have calculated the response with and without an oil layer, and plotted the difference as a percent of the response of the model without the oil. The percentage response is plotted as color shading on the aforementioned amplitude plots for the relevant measured field component as a function of depth and transmitter offset as in FIG. 2. We have only plotted those results that reveal the nearby resistive layer within the constraints of current practical transmitter moments and receiver sensitivity. It would be obvious that the ideas disclosed are not limited to these T-R configurations but could be extended to others as the technology evolves.

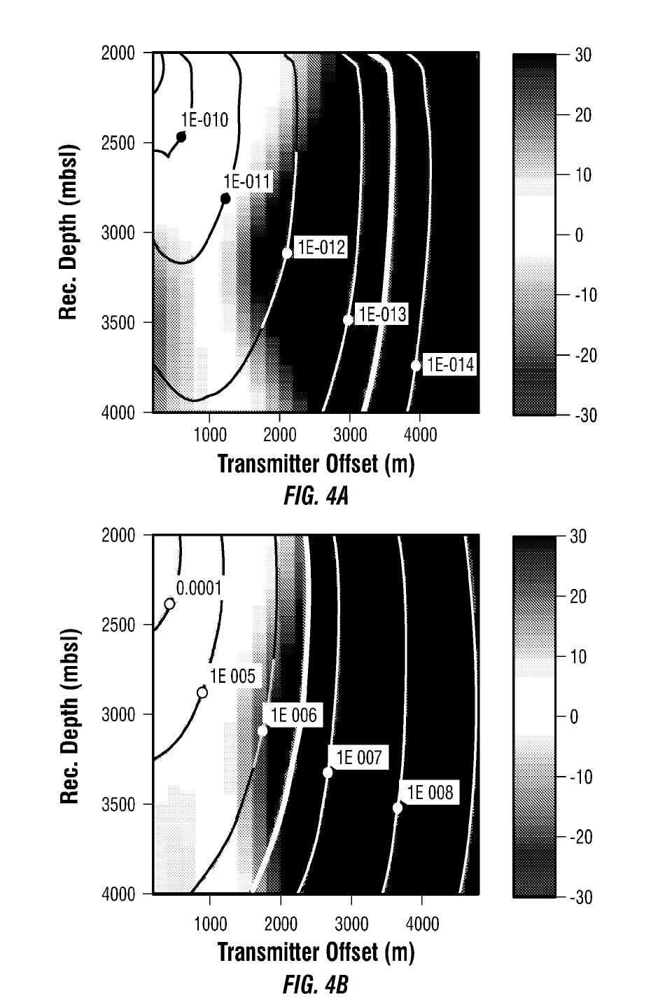

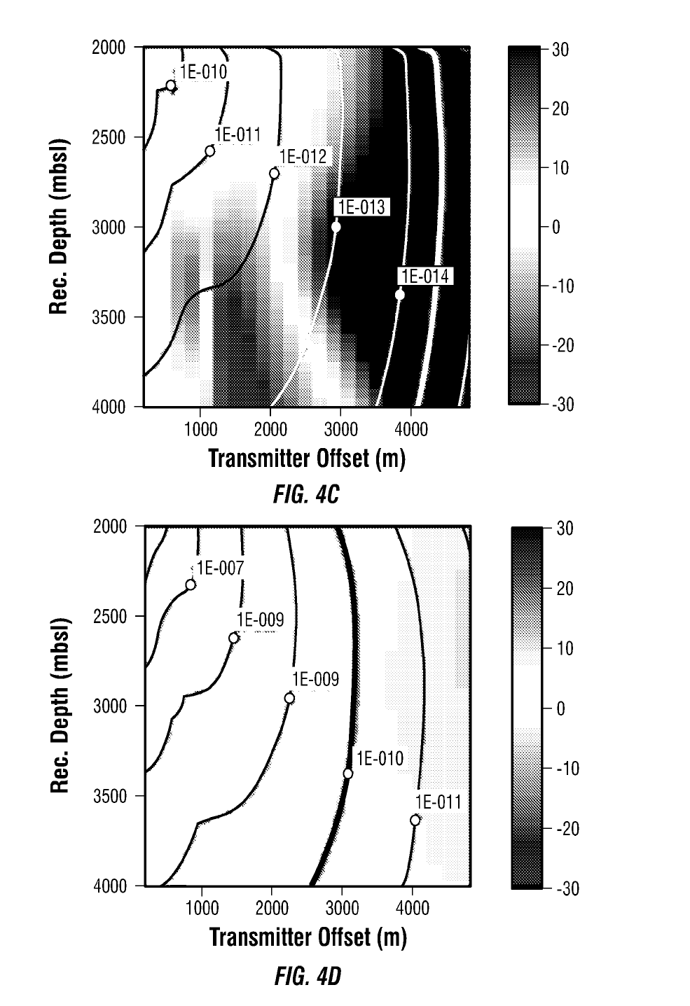

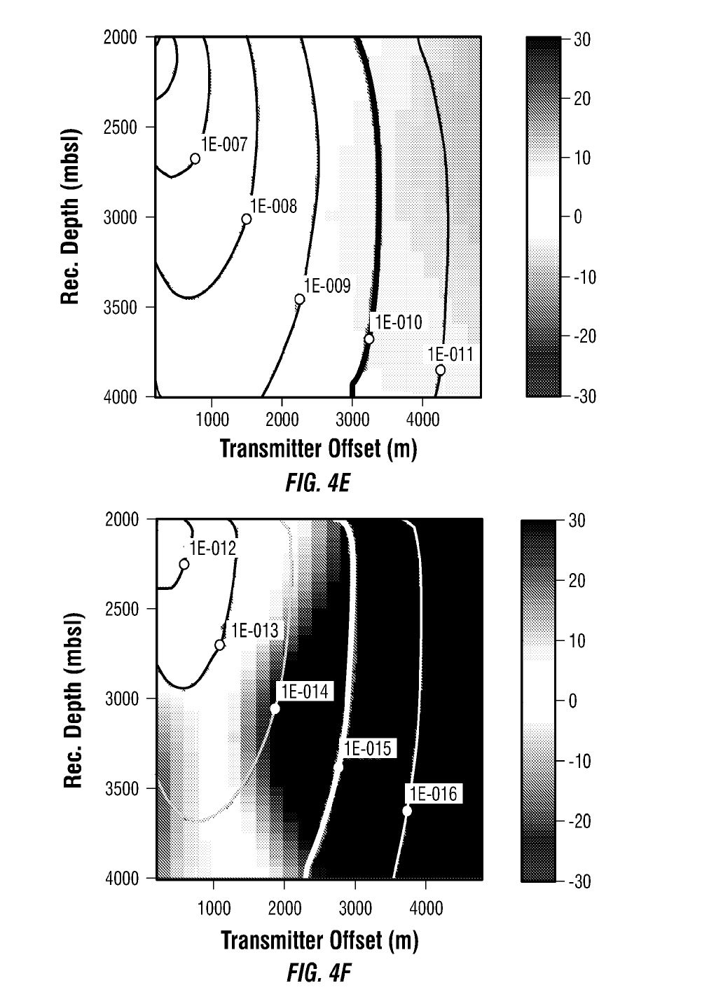

FIG. 4 shows the present practicality of the invention. Each panel of FIG. 4 shows the threshold sensitivity for the particular T-R pair as a heavy bold contour on the depth-offset amplitude response as described for FIG. 2. Generally measurements to the left of this contour can be made to 1% accuracy.

It is immediately evident that the best results are obtained when the vertical electric field is measured in the borehole for either horizontal or vertical electric sources, FIG. 4a,c and f. Horizontal Hy in the borehole from the horizontal MEx source is also feasible, FIG. 4b. The others shown are less practical but definitely possible. In steel cased wells, it may not be possible to measure Ez with the required accuracy but in exploratory wells, the lower part of the well remains open briefly to allow conventional logging at the depths of interest, and surface to borehole surveys could be conducted at the same time before the well is completed. It should be also noted that if the oil is not detected in the well at the anticipated depth, the hole could be drilled deeper and left uncased to perform the surface to borehole survey. As can be seen, for example in FIG. 4c, there is strong sensitivity to the nearby oil layer in measurements made below the oil horizon that in this case is at 3000 mbsl.

The above examples are for measurements made in the frequency domain. The same sensitivities can be demonstrated in the time domain, meaning measurements of the transient decay of either electric or magnetic field after the termination of current in the source.

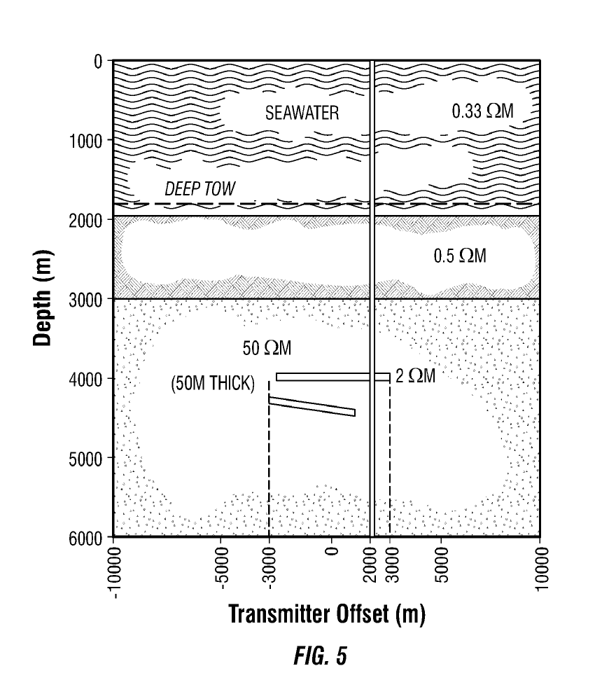

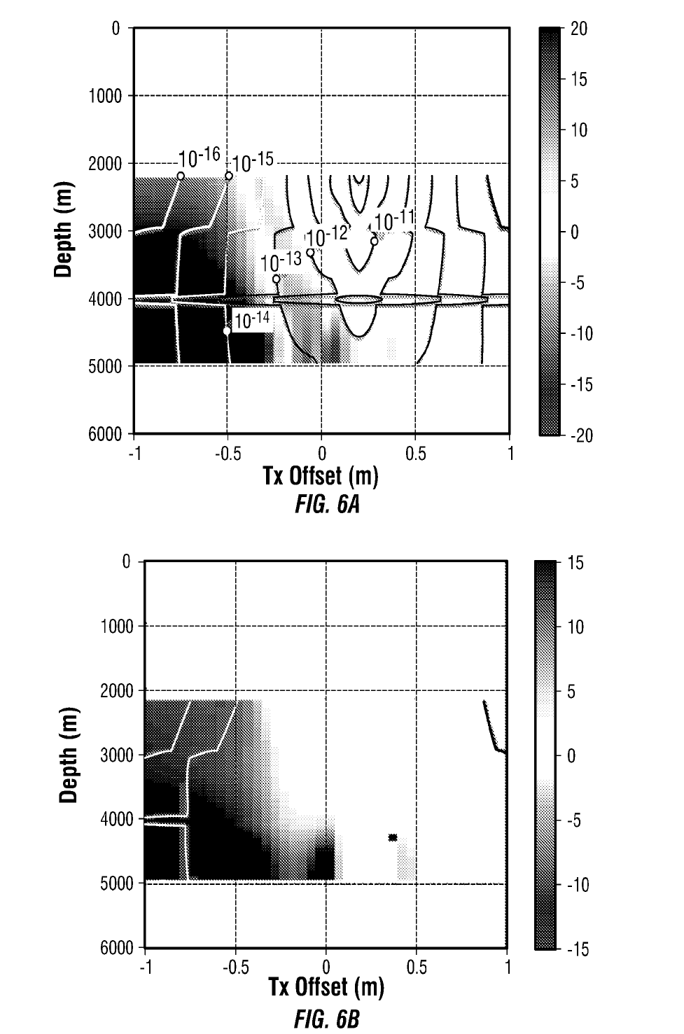

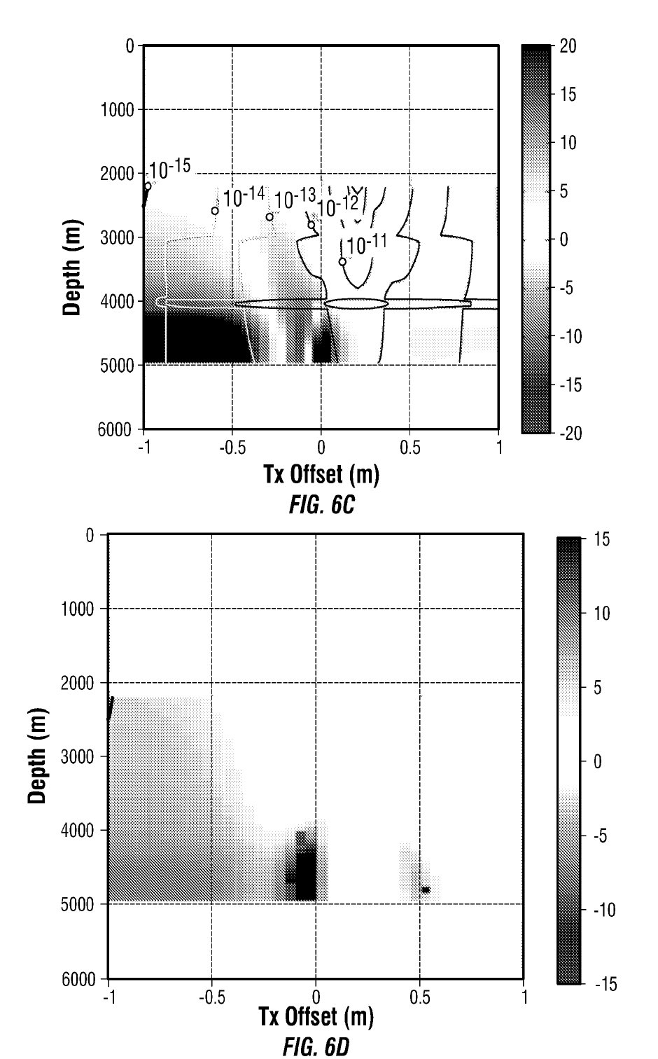

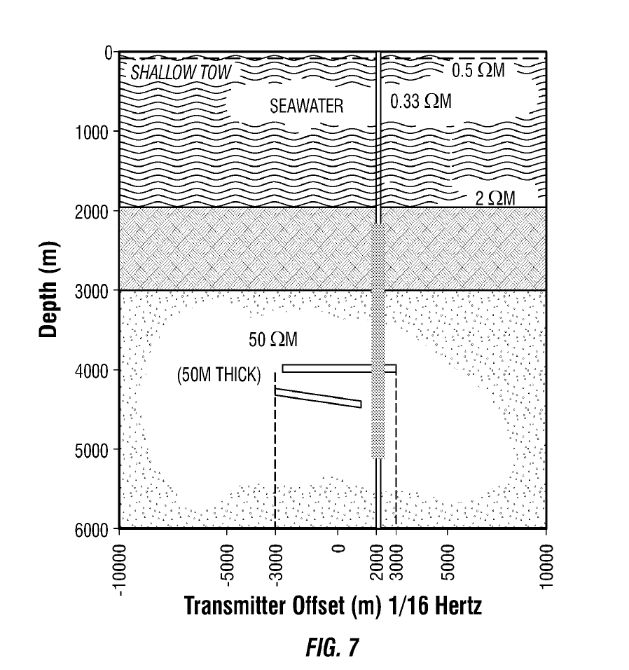

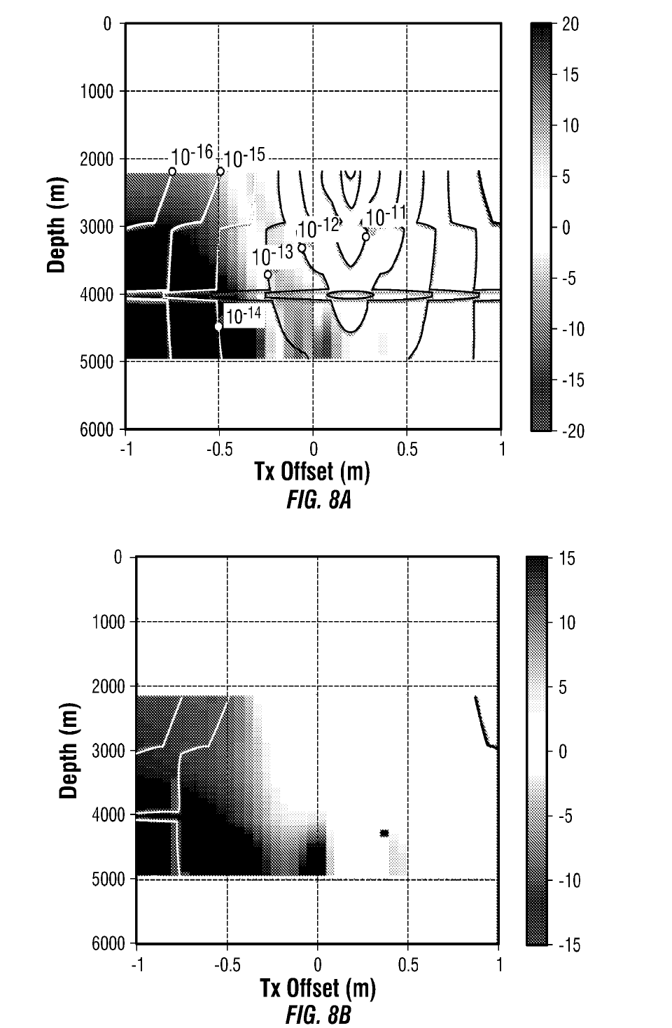

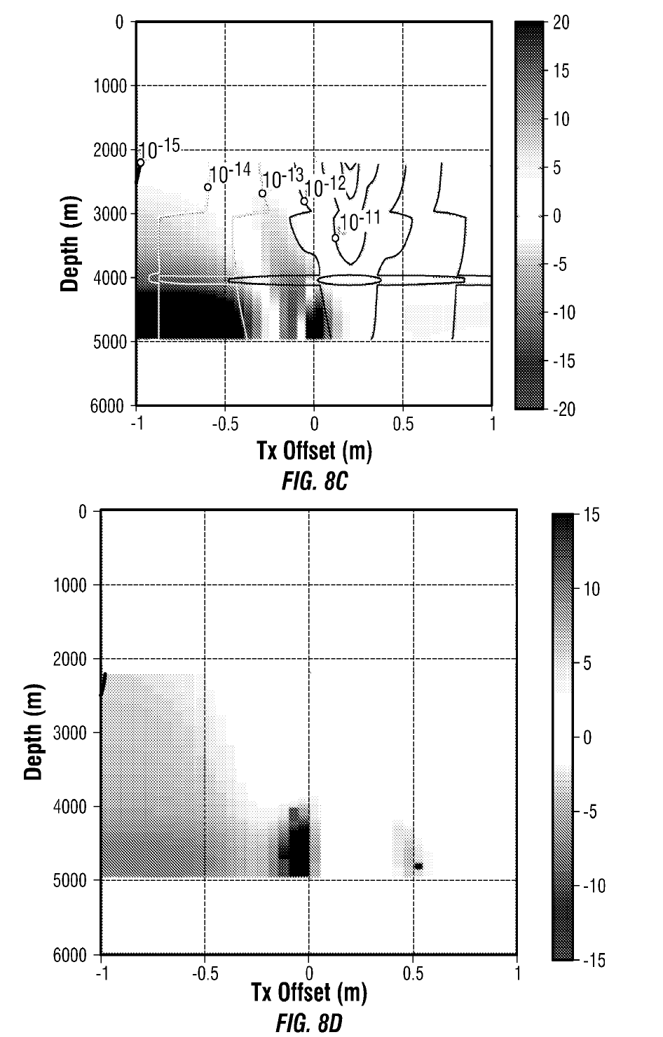

The following FIGS. 5-8 (FIG. 5 showing a deep-towed source in 2 km of seawater, FIG. 7 showing a shallow-towed source in 2 km of seawater, and FIGS. 6 and 8 showing the plotted response for each configuration respectively) show the formation anomaly is the essentially the same for a surface source (shallow towed source) as compared to a deeply-towed source, and the field strength drops, which can be overcome by additional power. In the marine source to borehole geometry, we can employ a larger than normal main power supply which can be located on the deck of the ship to provide sufficient power to overcome the field strength lost, and surface, or shallowly towed, sources.

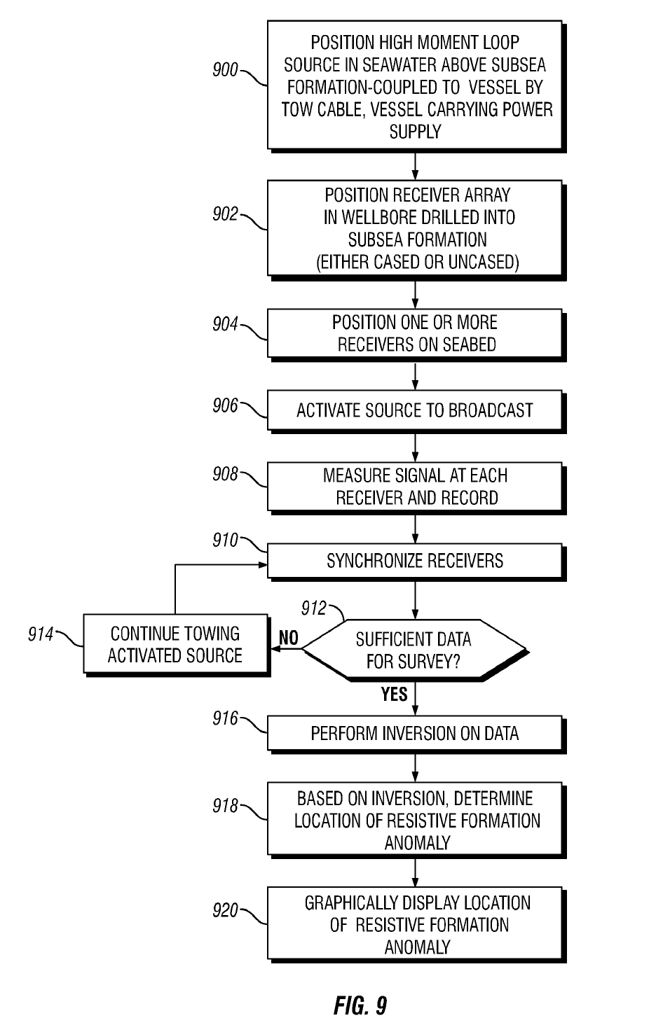

Referring now to FIG. 9, a flowchart for a method for conducting a towed high moment loop source to borehole receiver EM survey is provided. In step 900, a high moment loop source is towed in seawater at some position above the sea floor, preferably at as shallow a depth as possible. The more shallow a depth the source is towed at, the less the source has to be hardened to withstand deep water pressures, the less energy is lost to resistive heating along the tow cable, and the faster the vessel can move, shortening acquisition time.

In step 902, a receiver array is positioned in a wellbore, which may be cased or uncased. Optionally, in step 904, one or more receivers may be positioned at the seabed as well.

With transmitter and receiver(s) positioned in the various positions described above, in step 906, the high moment loop source is activated to broadcast a signal. The broadcast signal is measured and recorded at each receiver in the various locations, at step 908. The signal received at each receiver can be synchronized with the signals received at each other receiver using a GPS clock, as is well known (step 910).

If sufficient data has been gathered to generate an analysis of formation characteristics in the depth range of interest (i.e., resistivity in the deep volume about the wellbore), then at 912, the survey is complete, but if not, the high moment loop source is moved to a new position (either towed to another location or a new depth) at step 914, and the method repeats back to step 906, with the mobile transmitter being activated to broadcast the EM signal.

When the survey is complete at 912, then at step 916, the signal measurements are inverted, in accordance with the many inversion techniques that are well known in the art, and some of which are described and/or claimed in the related art listed above, and incorporated by reference in their entirety. From the inversion, a location of a resistive formation anomaly, such as a thin layer of oil, can be determined at step 918, and graphically displayed in step 920. The output of the location of a resistive formation anomaly and/or graphical display at step 920 may be used in planning drilling, going back for bypassed oil, and/or managing production.

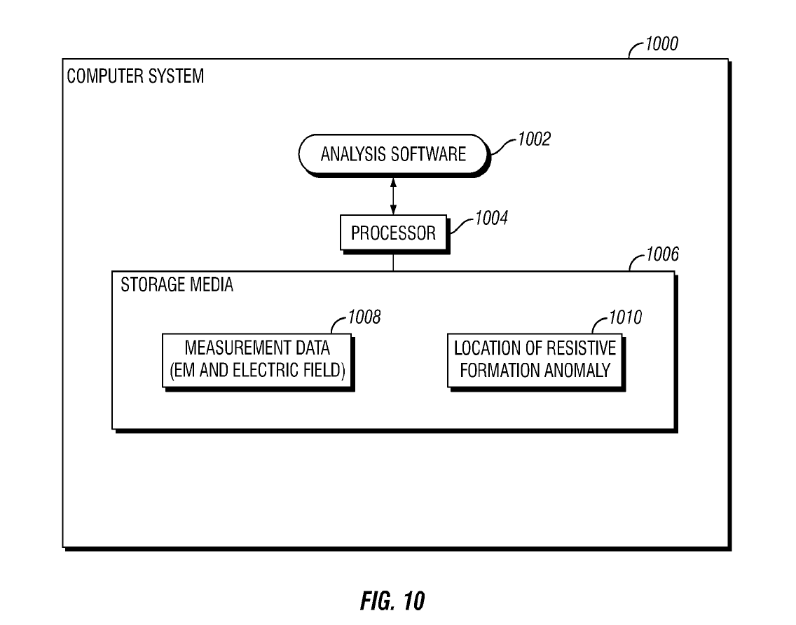

FIG. 10 illustrates a computer system 1000 that can be used to perform some of the tasks above according to an embodiment. The computer system 1000 includes analysis software 1002 that is executable on a processor 1004. The processor 1004 is connected to storage media 1006, which stores field measurement data 1008 received from the receivers. The storage media 1006 can be implemented with one or more disk-based storage devices or integrated circuit (IC) storage devices. Also, the storage media 1006 stores determined location of an oil layer (or other resistive formation anomaly) based on the field measurement data 1008.

The tasks that can be performed by the analysis software 1002 include using measurement data 1008 to perform inversion to determine the location of the formation anomaly, such as an oil reservoir, which is then stored at 1010.

Instructions of software described above (including the analysis software 1002 of FIG. 10) are loaded for execution on a processor (such as processor 1004 in FIG. 10). The processor includes microprocessors, microcontrollers, processor modules or subsystems (including one or more microprocessors or microcontrollers), or other control or computing devices. A “processor” can refer to a single component or to plural components (e.g., one or multiple central processing units in one or more computers).

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

While the invention has been disclosed with respect to a limited number of embodiments, those skilled in the art, having the benefit of this disclosure, will appreciate numerous modifications and variations therefrom. It is intended that the appended claims cover such modifications and variations as fall within the true spirit and scope of the invention.

What is claimed is:

1. A method conducting an electromagnetic (EM) deep reservoir survey of a subsea formation, comprising:
a. positioning a series of electromagnetic (EM) receivers in a subsea wellbore;
b. towing a high moment loop source by a vessel in seawater over the subsea formation, the source having a high power supply positioned at the vessel;
c. activating the high moment loop source to produce a field;
d. substantially continuously recording the field, attenuated by the formation, detected at each EM receiver as the high moment loop source moves through the seawater, wherein the field comprises one selected from the group selected from a magnetic field, an electric field, and a magnetic field and an electric field; and
e. performing an inversion to determine a location of an electrically resistive formation anomaly at a depth of between 1 to 5 km.

2. The method according to claim 1, wherein for the field to produce a measurable current at a depth d in the formation, the depth is on the order of one to three times the skin depth.

3. The method according to claim 1, wherein the high moment loop source comprises a vertical loop source having a magnetic moment of MBₓ or MB_{y} on the order of 10⁷ Amp.m².

4. The method according to claim 1, wherein the high moment loop source comprises a single turn loop of 10⁵ m² approximately 100 Amp, producing a magnetic moment of 10⁷ Amp.m².

5. The method according to claim 1, wherein the field is attenuated by 1/e over a distance δ, and the skin depth, given by 500 √ρ/f where ρ is the resistivity (ohm.m) and f the frequency (Hz).

6. The method according to claim 1, wherein the field comprises a vertical electric borehole field produced by a source selected from a horizontal electric source, a vertical electric source, and a y-directed magnetic dipole source.

7. The method according to claim 1, further comprising permanently installing the series of EM receivers in the wellbore.

8. The method according to claim 1, further comprising deploying the series of EM receivers in the wellbore via a wireline deployment technique selected from the group consisting of a tractor, coiled tubing, and drill pipe.

9. A towed marine source to borehole electromagnetic survey system comprising:
a sea vessel adapted for traversal of sea water over a subsea formation;
a power supply affixed to the sea vessel;
a high moment loop source coupled to the power supply and a signal generator by a tow cable; said signal generator being affixed to the sea vessel configured to control operating parameters of the high moment loop source;
a wellbore drilled in the subsea formation;
a series of electromagnetic (EM) receivers positioned in the wellbore;
each receiver comprising: a sensor module having sensing elements to measure one or more of electric fields, electric currents, and magnetic fields produced by the high moment loop source when towed by the sea vessel, and a storage device configured to store data from measurements made by the sensor module; and
a computer processor configured to receive stored data from the receivers and analyze the stored measurement data to determine a location of an electrically resistive formation anomaly at a depth of between 1 to 5 km.

10. The system according to claim 9, wherein the high moment loop source comprises a vertical loop source having a magnetic moment of MBₓ or MB_{y} on the order of 10⁷ Amp.m².

11. The system according to claim 9, wherein the high moment loop source comprises a single turn loop of 10⁵ m² approximately 100 Amp, producing a magnetic moment of 10⁷ Amp.m².
